(19) United States
(12) Patent Application Publication
(10) Pub. No.: US 2009/0276108 A1
(43) Pub. Date: Nov. 5, 2009

(54) SYSTEM AND METHOD FOR PROCESSING IMAGES OF WAYSIDE EQUIPMENT ADJACENT TO A ROUTE

(76) Inventors: Ajith Kuttannair Kumar, Erie, PA (US); Glenn Robert Shaffer, Erie, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/113,454

(22) Filed: May 1, 2008

(51) Int. Cl. G06F 19/00; G06K 9/00

(52) U.S. Cl. 701/20; 382/104

(57) ABSTRACT

A system is provided for processing images of wayside equipment adjacent to a route. The system includes a video camera configured to collect visible spectral data of the wayside equipment. The video camera is positioned on an external surface of a powered system traveling along the route. Additionally, the system includes a controller coupled to the video camera, where the controller is configured to process the visible spectral data, and is further configured to transmit a signal based upon processing the visible spectral data. Additionally, a method and computer readable media are provided for processing images of wayside equipment adjacent to a route.

### BACKGROUND OF THE INVENTION

In conventional locomotive imaging systems, cameras collect video information of the locomotive or a surrounding railroad system which is typically stored in a memory of a processor. However, these conventional locomotive imaging systems do not automatically process the video information on a real-time basis. This video information, which may include the color of a signaling light, or a wayside equipment signaling condition, for example, if processed, may provide valuable navigational information for the locomotive.

Thus, it would be advantageous to provide a system which processes the video information collected while a locomotive travels along a railroad, since the processing of such video information would provide valuable information during the operation of the locomotive.

### BRIEF DESCRIPTION OF THE INVENTION

One embodiment of the present invention provides a system for processing images of wayside equipment adjacent to a railroad or other vehicle route. The system includes a video camera configured to collect visible spectral data of the wayside equipment. The video camera is positioned on an external surface of a locomotive or other powered system traveling along the railroad or other route. Additionally, the system includes a controller coupled to the video camera, where the controller is configured to process the visible spectral data, and is further configured to transmit a signal based upon processing the visible spectral data.

Another embodiment of the present invention provides a method for processing images of wayside equipment adjacent to a railroad. The method includes collecting visible spectral data of the wayside equipment with a video camera positioned on an external surface of a locomotive traveling along the railroad. The method additionally includes processing the visible spectral data with a controller coupled to the video camera. The method further includes transmitting a signal from the controller based upon the processing of the visible spectral data.

Another embodiment of the present invention provides computer readable media for processing images of wayside equipment adjacent to a railroad. In executing the computer readable media, visible spectral data of the wayside equipment is collected with a video camera upon positioning the video camera on an external surface of a locomotive traveling along the railroad. The computer readable media includes a computer program code for processing the visible spectral data with a controller coupled to the video camera. Additionally, the computer readable media includes a computer program code for transmitting a signal from the controller based upon the processing of the visible spectral data.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a side view of an exemplary embodiment of a locomotive within a system for processing images of wayside equipment according to the present invention;

FIG. 2 is a side view of an exemplary embodiment of a locomotive within the system for processing images of wayside equipment illustrated in FIG. 1;

FIG. 3 is an exploded view of an exemplary embodiment of a system for processing images of wayside equipment according to the present invention;

FIG. 4 is a plan view of a display from the system for processing images of wayside equipment illustrated in FIG. 1;

FIG. 5 is a top view of an exemplary embodiment of a locomotive within the system for processing images of wayside equipment illustrated in FIG. 1; and

FIG. 6 is a flow chart illustrating an exemplary embodiment of a method for processing images of wayside equipment according to the present invention.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

Though exemplary embodiments of the present invention are described with respect to rail vehicles, or railway transportation systems, specifically trains and locomotives having diesel engines, exemplary embodiments of the invention are also applicable for other uses, such as but not limited to off-highway vehicles, marine vessels, stationary units, agricultural vehicles, and transport buses, each which may use at least one diesel engine, or diesel internal combustion engine. Towards this end, when discussing a specified mission, this includes a task or requirement to be performed by the diesel powered system. Therefore, with respect to railway, marine, transport vehicles, agricultural vehicles, or off-highway vehicle applications this may refer to the movement of the system from a present location to a destination. In the case of stationary applications, such as but not limited to a stationary power generating station or network of power generating stations, a specified mission may refer to an amount of wattage (e.g., MW/hr) or other parameter or requirement to be satisfied by the diesel powered system. Likewise, operating conditions of the diesel-fueled power generating unit may include one or more of speed, load, fueling value, timing, etc. Furthermore, though diesel powered systems are disclosed, those skilled in the art will readily recognize that embodiments of the invention may also be utilized with non-diesel powered systems, such as but not limited to natural gas powered systems, bio-diesel powered systems, etc. Furthermore, as disclosed herein such non-diesel powered systems, as well as diesel powered systems, may include multiple engines, other power sources, and/or additional power sources, such as, but not limited to, battery sources, voltage sources (such as but not limited to capacitors), chemical sources, pressure based sources (such as but not limited to spring and/or hydraulic expansion), current sources (such as but not limited to inductors), inertial sources (such as but not limited to flywheel devices), gravitational-based power sources, and/or thermal-based power sources.

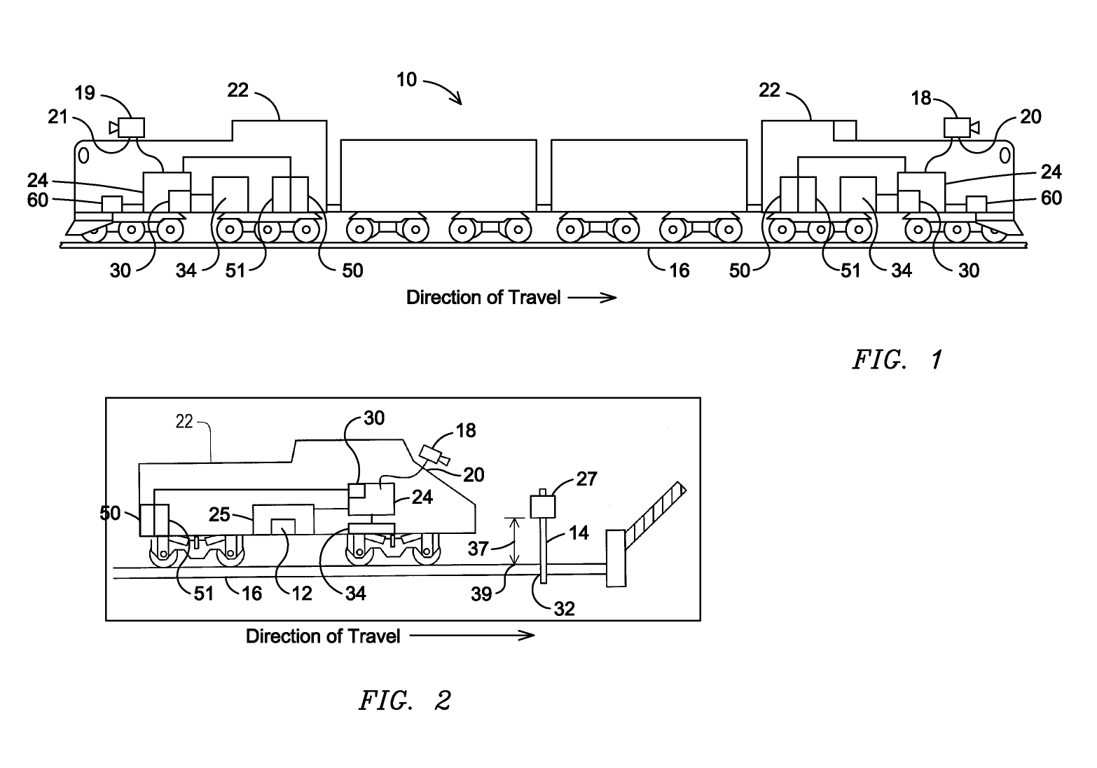

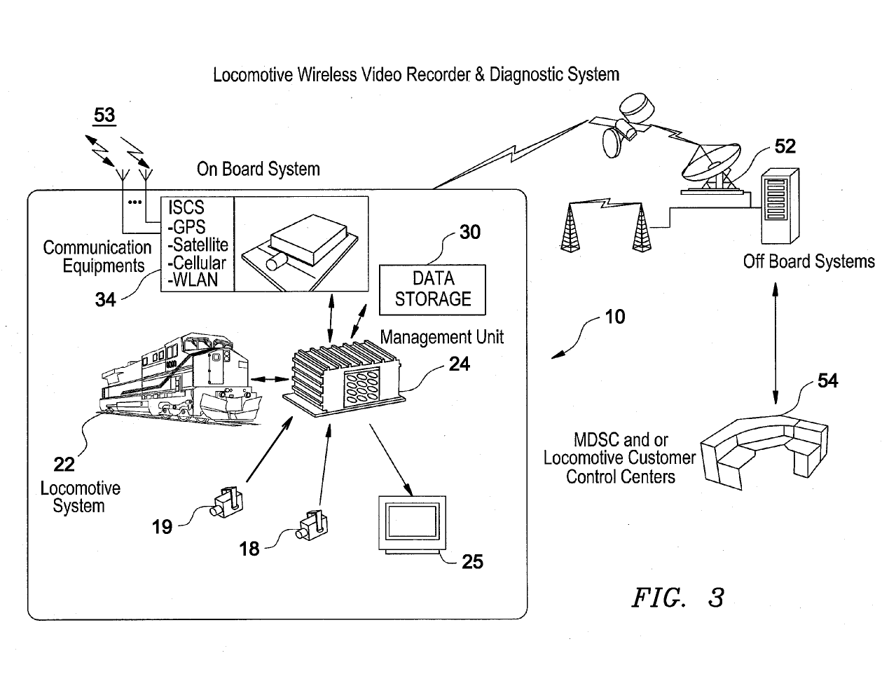

FIGS. 1-2 illustrate an embodiment of a system 10 for processing images 12 of wayside equipment 14 adjacent to a railroad 16. The system 10 includes a controller 24 within a locomotive 22. FIG. 1 illustrates a distributive power arrangement, in which two locomotives 22 are separated by a plurality of train cars, while FIG. 2 illustrates a single locomotive arrangement. The embodiments of the present invention discussed herein are not limited to either of the arrangements illustrated in FIGS. 1 and 2. A plurality of video cameras, such as a forward looking camera 18 and a rearward looking camera 19 are positioned on a respective front and rear external surface 20,21 of the locomotive 22. Each video camera 18,19 is configured to collect visible spectral data of the wayside equipment 14 as the locomotive 22 travels along the railroad 16. The controller 24 is coupled to the video camera 18 (FIG. 2), or alternatively, a respective controller 24 may be coupled to each video camera 18,19 (FIG. 1), to process the visible spectral data. Additionally, the controller 24 is configured to transmit a signal based upon processing the visible spectral data, such as to the locomotive engine 50, for example. This signal may be used to change an operational condition of the locomotive 22. In an exemplary embodiment, an operational condition of the locomotive 22 may include various transportational modes, such as a braking mode, for example, in addition to activation or control of a number of subsystems of the locomotive, such as an audible warning device, for example, as discussed in further detail below.

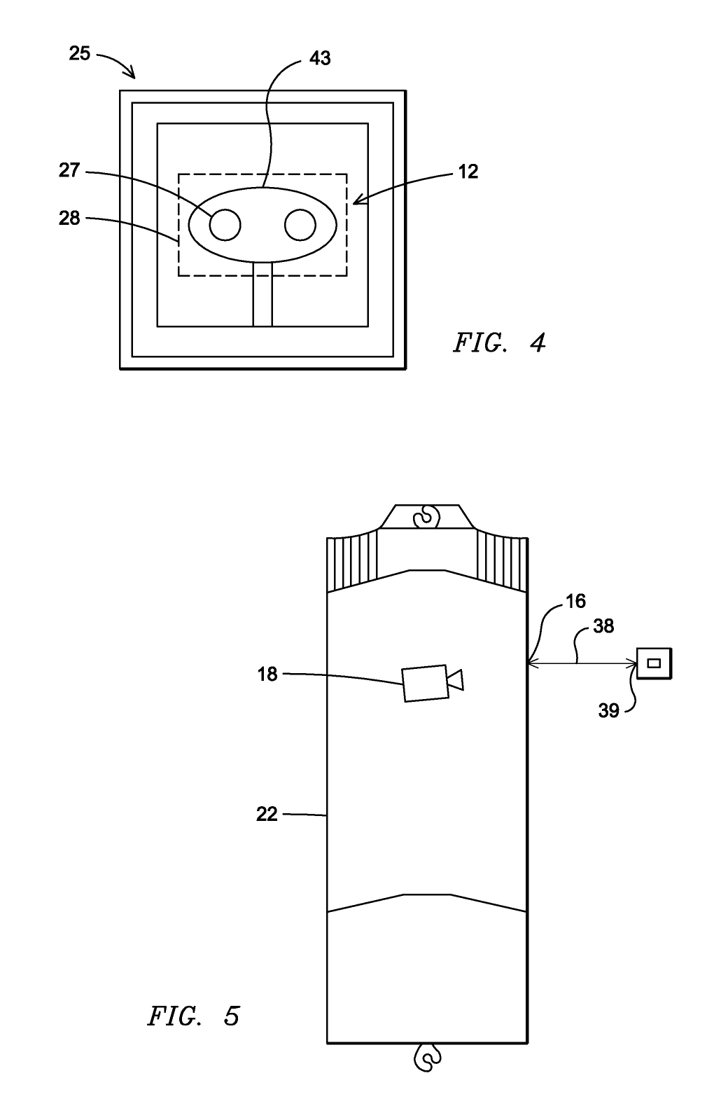

As illustrated in FIG. 2, the wayside equipment 14, whose spectral data is collected and processed by the video cameras 18,19 and controller 24, may be a light signal or a track number indicator for the locomotive 22, for example. As illustrated in FIG. 4, a display 25 (FIG. 2) shows the images 12 of the wayside equipment 14 subsequent to the collection of spectral data from the wayside equipment 14 by the video cameras 18,19. Each video camera 18,19 may be configured to process pixels within an adjustable field of view 28, where the adjustable field of view of the video camera is adjusted to coincide with some or all of the wayside equipment 14. For example, in the exemplary embodiment of FIG. 4, the adjustable field of view 28 of the video cameras 18,19 is adjusted such that the light signal portion 27 (FIG. 2) of the wayside equipment 14 is visible on the display 25.

Additionally, as illustrated in FIGS. 1-2, the controller 24 includes a memory 30 configured to store one or more expected positions 32 of the wayside equipment 14 along the railroad 16. For example, the memory 30 may store one or more distances for a particular track number from a fixed position, and thus the locomotive operator may retrieve these stored distances to determine the positions of the wayside equipment 14. Additionally, the memory 30 may store one or more position coordinates of the wayside equipment 14 and the system 10 may include a position determination device 34, such as a GPS device, for example, coupled to the controller 24 to determine a position of the locomotive 22 along the railroad 16. The controller 24 is configured to compare the stored position coordinates of the wayside equipment 14 with the present position of the locomotive 22 based on the position determination device 34. Once the locomotive 22 reaches the expected position 32 of the wayside equipment, the controller 24 arranges for the video cameras 18,19 to collect the visible spectral data of the wayside equipment 14. In collecting the visible spectral data of the wayside equipment 14, the field of view 28 (FIG. 4) of the video cameras 18,19 are adjusted to collect the visible spectral data of the wayside equipment 14 positioned at the expected position 32.

FIG. 3 illustrates an exemplary embodiment of a system 10 and the communications between the (on-board) system 10 and external devices, such as a satellite receiver 52 and/or a command center 54, for example. The satellite receiver 52 may provide position information of the locomotive 22 to a transceiver 53 on the locomotive 22 which is then communicated to the controller 24. The progress of the locomotive 22, in terms of properly processing spectral data of each wayside equipment 14 at each expected position 32 may be externally monitored (automatically or manually by staff) by the command center 54.

In an exemplary embodiment of the present invention, the memory 30 may further store one or more position parameters of the wayside equipment 14 at each expected position 32. The field of view 28 is adjusted based upon the one or more stored position parameters to collect the visible spectral data of the wayside equipment 14 positioned at the expected position 32. As illustrated in FIG. 2, once the locomotive 22 reaches an expected position 32 of the wayside equipment 14, the controller 24 is configured to align the video cameras 18,19 with the wayside equipment 14 based upon on the position parameters. Examples of such position parameters include a perpendicular distance 37 from a ground portion 39 to the light signal portion 27 of the wayside equipment 14 (FIG. 2), and a perpendicular distance 38 from a portion of the railroad 16 to the ground portion 39 (FIG. 5).

When the wayside equipment 14 is a light signal, the memory 30 is configured to store an expected color of the light signal positioned at the expected position 32. Additionally, the memory 30 is configured to store an expected profile of the light signal frame 43 at the expected position 32 and is further configured to store an expected position of the wayside equipment 14, such as the light signal 14 having the expected color along the light signal frame 43 (FIG. 4). For example, as illustrated in FIG. 4, the memory 30 may store that the light signal portion 27 of the light signal 14 along the light signal frame 43 are a pair of centered light signals along the light signal frame 43.

In an exemplary embodiment, the signal generated by the controller 24 is based upon comparing the expected color stored in the memory 30 with a detected color of the wayside equipment 14, and the signal is configured to switch the locomotive 22 into one of a motoring mode and a braking mode. The motoring mode is an operating mode in which energy from a locomotive engine 50 or an energy storage device 51 (FIGS. 1-2) is utilized in propelling the locomotive 22 along the railroad 16, as appreciated by one of skill in the art. The braking mode is an operating mode in which energy from a locomotive engine 50 or locomotive braking system is stored in the energy storage device 51 (FIG. 2). Although the embodiments illustrated in FIGS. 1-2 involve the signal generated by the controller 24 being sent to the engine 50 to switch the locomotive 22 into the motoring mode or the braking mode, the controller 24 may transmit the signal to the engine 50 to reduce the power notch setting or limit the power notch setting of the engine 50, for example. In addition, the controller 24 may transmit the signal to the memory 30, to record each signal and thus the performance of the system 10, for subsequent analysis. For example, after the locomotive 22 has completed a trip, the controller 24 signals stored in the memory 30 may be analyzed to determine whether the system 10 was executed properly. In addition, the controller 24 may transmit the signal to other devices within the system 10 to generate different responses based on the processing of the visible spectral data. For example, the controller 24 may transmit the signal to an audible warning device 60, such as a horn, for example. As another example, the controller 24 may transmit the signal to a headlight of the locomotive 22. Thus, the controller 24 may transmit the signal to any device within the locomotive 22, to initiate an action based upon the processing of the visible spectral data from the light signal 14. In an exemplary embodiment, if the controller 24 determines that the color of the light signal 14 does not correspond with the expected color of the light signal 14 stored in the memory 30, the controller 24 may transmit a signal to the engine 50 to initiate the braking mode to slow down the locomotive 22 or transmit a signal to the audible warning device 60, to alert the operator of a possible dangerous condition, for example.

In the exemplary embodiment where the wayside equipment 14 is a light signal, the video cameras 18,19 are configured to process a plurality of frames of the light signal portion 27 to determine if the light signal 14 is in one of a flashing mode and non-flashing mode. For example, the video cameras 18,19 would generate a multiple set of images 12, as illustrated in FIG. 4, and determine whether or not the light signals are flashing or not. The light signal 14 in the flashing mode is indicative of a particular upcoming condition along the railroad, such as a dangerous condition, for example. In the locomotive 22 cabin, a single operator may be used to operate the locomotive. As stated above, in an exemplary embodiment, in response to the controller 24 determining that the light signal 14 is in the flashing mode indicative of a dangerous condition, the controller may transmit the signal to the engine 50 to initiate the braking mode, the motoring mode, to modify or limit a power notch setting or transmit the signal to the audible warning device 60, to alert the operator of a possible dangerous condition, for example.

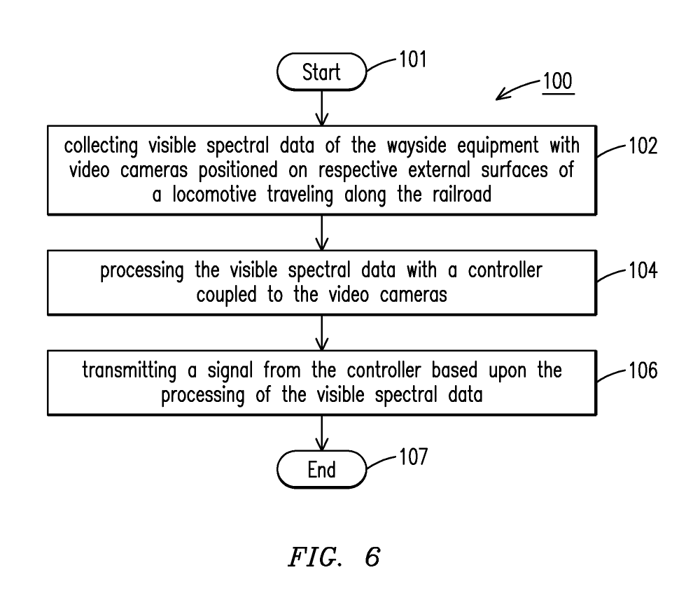

FIG. 6 illustrates an exemplary embodiment of a method 100 for processing images 12 of wayside equipment 14 adjacent to a railroad 16. The method 100 begins at 101 by collecting 102 visible spectral data of the wayside equipment 14 with video cameras 18,19 positioned on respective external surfaces 20,21 of a locomotive 22 traveling along the railroad 16. The method 100 further includes processing 104 the visible spectral data with a controller 24 coupled to the video cameras 18,19. The method 100 further includes transmitting 106 a signal from the controller 24 based upon processing of the visible spectral data, before ending at 107.

Based on the foregoing specification, the above-discussed embodiments of the invention may be implemented using computer programming or engineering techniques including computer software, firmware, hardware or any combination or subset thereof, wherein the technical effect is to process images of wayside equipment adjacent to a railroad. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any emitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments the invention.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A system for processing images of wayside equipment adjacent to a route, said system comprising:
a camera configured to collect visible spectral data of said wayside equipment, said video camera positioned on an external surface of a powered system traveling along said route; and
a controller coupled to said camera, said controller configured to process said visible spectral data, said controller being configured to transmit a signal based upon processing said visible spectral data, said signal being used to control an operational condition of the powered system.

2. The system of claim 1, wherein said powered system is one of an off-highway vehicle, a marine propulsion vehicle, and a rail vehicle.

3. The system of claim 2, wherein said powered system is a rail vehicle traveling along a railroad, said wayside equipment is one of a light signal and a track number indicator.

4. The system of claim 3, wherein said video camera is configured to process pixels within an adjustable field of view, said adjustable field of view being adjusted to coincide with said wayside equipment.

5. The system of claim 4, wherein said controller includes a memory configured to store at least one expected position of said wayside equipment along said railroad.

6. The system of claim 5, further comprising a position determination device to determine a position of said locomotive along said railroad, said video camera being configured to collect said visible spectral data of said wayside equipment positioned at said expected position.

7. The system of claim 6, wherein said field of view is adjusted to collect said visible spectral data of said wayside equipment positioned at said expected position.

8. The system of claim 5, further comprising a position determination device to determine a position of said locomotive along said railroad, said memory being configured to further store at least one position parameter of said wayside equipment at each expected position.

9. The system of claim 8, wherein said field of view is adjusted based upon said at least one stored position parameter to collect said visible spectral data of said wayside equipment positioned at said expected position.

10. The system of claim 8, wherein said controller is configured to align said video camera with said wayside equipment at each expected position based upon said at least one position parameter.

11. The system of claim 10, wherein said at least one position parameter comprises at least one of a perpendicular distance from a ground portion to said wayside equipment and a distance from a portion of said railroad to said ground portion.

12. The system of claim 5, wherein said wayside equipment is a light signal, said memory is further configured to store an expected color of said light signal positioned at said expected position.

13. The system of claim 12, wherein said memory is further configured to store an expected profile of a light signal frame at said expected position and is further configured to store an expected position of said light signal having said expected color along said light signal frame.

14. The system of claim 12, wherein said signal is based upon said expected color, said signal from said controller configured to switch said locomotive into one of a motoring mode and a braking mode, said motoring mode being an operating mode in which energy from one of a locomotive engine and an energy storage device is utilized in propelling said locomotive along said railroad, said braking mode being an operating mode in which energy from one of a locomotive engine and locomotive braking system is stored in said energy storage device.

15. The system of claim 4, wherein said wayside equipment is a light signal, said video camera is configured to process a plurality of frames of said light signal to determine if said light signal is in one of a flashing mode and non-flashing mode.

16. The system of claim 15, wherein said light signal being in said flashing mode is indicative of a particular upcoming condition along said railroad.

17. The system of claim 4, wherein said locomotive includes a single operator.

18. A method for processing images of wayside equipment adjacent to a route, said method comprising:
collecting visible spectral data of said wayside equipment with a video camera positioned on an external surface of a powered system traveling along said route;
processing said visible spectral data with a controller coupled to said video camera; and
transmitting a signal from said controller based upon said processing of said visible spectral data.

19. The method of claim 18, wherein said powered system is one of an off-highway vehicle, a marine propulsion vehicle, and a rail vehicle.

20. The method of claim 19, wherein said powered system is a rail vehicle traveling along a railroad, said wayside equipment is one of a light signal and a track number indicator.

21. The method of claim 20, wherein said processing said visible spectral data comprises processing pixels within an adjustable field of view of said video camera, said adjustable field of view being adjusted to coincide with said wayside equipment.

22. The method claim 21, further comprising storing at least one expected position of said wayside equipment along said railroad within a memory of said controller.

23. The method of claim 22, further comprising:
determining a position of said locomotive along said railroad; and
collecting said visible spectral data of said wayside equipment positioned at said expected position.

24. The method of claim 22, further comprising:
determining a position of said locomotive along said railroad; and
storing at least one position parameter of said wayside equipment at each expected position within said memory.

25. The system of claim 24, further comprising adjusting said field of view based upon said at least one stored position parameter to collect said visible spectral data of said wayside equipment positioned at said expected position.

26. Computer readable media for processing images of wayside equipment adjacent to a railroad, wherein visible spectral data of said wayside equipment is collected with a video camera upon positioning the video camera on an external surface of a locomotive traveling along said railroad, said computer readable media comprising:
a computer program code for processing said visible spectral data with a controller coupled to said video camera; and
a computer program code for transmitting a signal from said controller based upon said processing of said visible spectral data.
